(19) United States
(12) Patent Application Publication
(10) Pub. No.: US 2005/0125217 A1
(43) Pub. Date: Jun. 9, 2005

(54) Server-based spell check engine for wireless hand-held devices

(76) Inventor: Gadi Mazor, Ramat Efal (IL)

Correspondence Address: PILLSBURY WINTHROP SHAW PITTMAN, LLP, P.O. BOX 10500, MCLEAN, VA, 22102, US

(21) Appl. No.: 10/976,415

(22) Filed: Oct. 29, 2004

Related U.S. Application Data
(60) Provisional application No. 60/514,906, filed on Oct. 29, 2003.

(51) Int. Cl. G06F 17/20

(52) U.S. Cl. 704/1

(57) ABSTRACT

A system and method are provided for enabling a wireless hand-held device to interface with a server-based spell check engine. A user views available features and functionality associated with a spell check engine on a graphical user interface (GUI) associated with a wireless hand-held device. The user performs interface actions of the spell checking process on the wireless hand-held device itself, such as observing the misspelled words, selecting a spelling from a list of alternatives, placing a word to a saved “ignore list”, or other display components associated with a spell check engine. Various functions of the spell checking process are performed remotely via a server-based spell check engine. The remote spell check engine includes a number of enhanced resources such as increased processing power and memory, a larger lexicon, a larger dictionary, or other enhanced spell-checking resources. Once spell check processing on the server is complete, results in a format that incorporate the original text are transmitted back to the wireless hand-held device.

### CROSS REFERENCE TO RELATED APPLICATIONS

This application is related to Provisional Patent Application Ser. No. 60/514,906 which is incorporated herein by reference.

### FIELD OF THE INVENTION

The invention relates to a server-based spell check engine for wireless hand-held devices.

### BACKGROUND OF THE INVENTION

Many word-processing applications, electronic mail applications, or other applications that enable users to input text, either incorporate spell check programs or interface with stand-alone spell check programs.

The various features and functionality of spell check programs are often maximized when the applications that incorporate or interface with them are hosted on desktop or portable (e.g., laptop) computers. While various wireless hand-held devices (e.g., a Palm Pilot, Blackberry, Personal Digital Assistant (PDA), web-enabled mobile phone, etc.) also utilize spell check programs or spell check engines, the limited resources (e.g., memory, processor speed) of such wireless hand-held devices often limits the strength of the spell check engine. For example, spell check engines for most wireless hand-held devices often include a lexicon than is quite limited when compared to a lexicon provided to users of desktop or laptop computers. This can be quite disadvantageous, particularly as individuals are increasingly relying on wireless hand-held devices for their personal and business communication needs.

These and other drawbacks exist.

### SUMMARY OF THE INVENTION

The invention solving these and other problems relates to a server-based spell check engine for wireless hand-held devices. In particular, a system and method are provided for enabling a wireless hand-held device to selectively interface with a server-based spell check engine.

According to various embodiments of the invention, a user may view available features and functions associated with a spell check engine on a graphical user interface (GUI) associated with a wireless hand-held device. Accordingly, the user may perform interface actions of the spell checking process on the wireless hand-held device itself, such as selecting whether to engage a spell check process, observing the misspelled words, selecting a spelling from a list of alternatives, placing a word to a saved “ignore list,” adding a word to a saved personal dictionary, or other functions associated with a spell check engine.

Further, various functions of the spell check process may be performed on a server remote from the wireless device. In particular, a server-based spell check engine may include a number of enhanced resources such as increased processing power and memory, a larger dictionary, or other enhanced spell-checking resources. The server-based spell check engine receives words or text to be checked for the wireless hand-held device. The server-based spell check engine may process the words or text and transmit the results back to the wireless hand-held device. The results may include indicia identifying each word that is potentially misspelled, as well potential corrections for each potentially misspelled word.

According to various embodiments of the invention, a user may select, in advance or at the time of each individual spell check process, to either have the spell check process performed by a local spell check engine hosted by the wireless hand-held device, or by a server-based spell check engine in communication with the wireless hand-held device. Processing by the local spell check engine may be more limited than processing by the server-based spell check engine, but may suffice if a user wishes to perform only a cursory spell check or if wireless access is not available.

These and other objects, features, and advantages of the invention will be apparent through the detailed description of the preferred embodiments and the drawings attached hereto. It is also to be understood that both the foregoing general description and the following detailed description are exemplary and not restrictive of the scope of the invention.

### BRIEF DESCRIPTION OF THE DRAWINGS

FIG. 1 illustrates a schematic diagram of a system for enabling a wireless hand-held device to interface with a server-based spell check engine, according to various embodiments of the invention.

FIG. 2 illustrates a schematic diagram of a data flow, according to various embodiments of the invention.

FIG. 3 illustrates a flowchart of processing according to various embodiments of the invention.

FIG. 4 illustrates a display of the results on a wireless hand-held device after the spell check process has been performed, according to various embodiments of the invention.

### DETAILED DESCRIPTION OF PREFERRED EMBODIMENTS

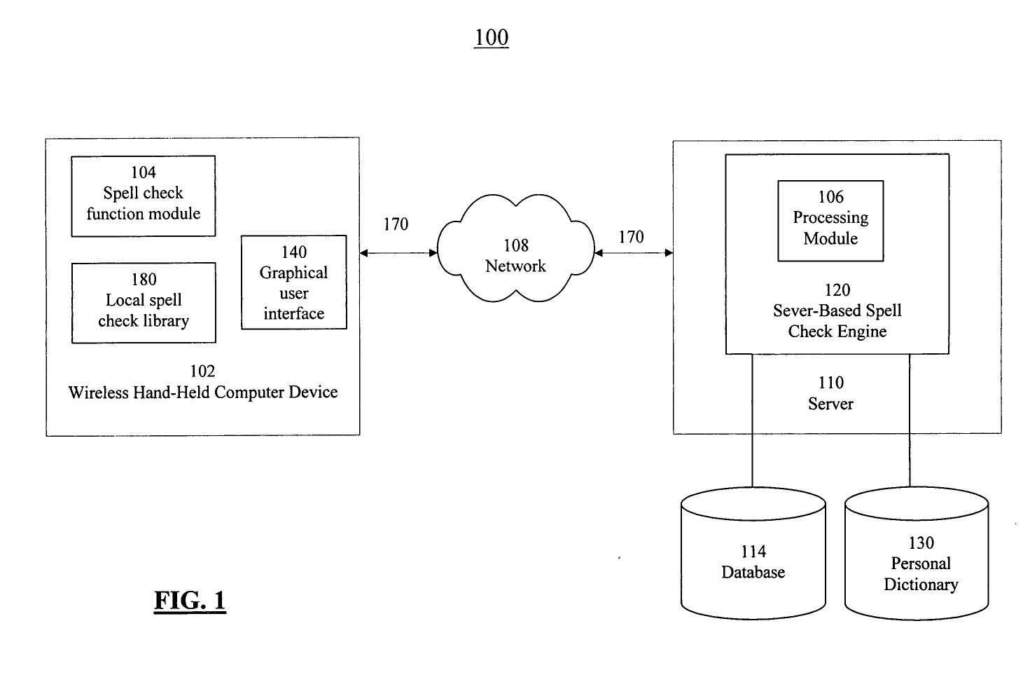

FIG. 1 illustrates a schematic diagram of a system for enabling a wireless hand-held device to operate with a server-based spell check engine, according to various embodiments of the invention. As illustrated in FIG. 1, a system 100 may include a wireless hand-held device 102 interfaced to a server-based spell check engine 120 hosted by a server 110.

According to various embodiments of the invention, wireless hand-held device 102 may host one or more known word processing applications (e.g., Microsoft Word), electronic mail applications (e.g., Microsoft Outlook), or other applications that enable users to input text. One or more of these applications my incorporate, interface with, or otherwise operate with a spell check function module 104 and/or a local spell check library 180. Various features and functions enabled by spell check function module 104, as described below, may be displayed to a user via graphical user interface (GUI) 104 on wireless handheld device 102.

In some embodiments of the invention, local spell check library 180 may include a smaller dictionary than a spell check dictionary, such as the dictionary used by server-based spell check engine 120. For example, local spell check library 180 may store the most commonly used words for a particular language. According to some embodiments of the invention, local spell check library 180 may include a portion of database 114. Wireless handheld devices are known to have limited bandwidth capabilities. By including a portion of the words found in a full spell check dictionary, bandwidth usage at wireless hand-held device 102 may be conserved because less storage space is needed.

According to some embodiments of the invention, spell check function module 104 may act as an interface between a selected spell check method and GUI 140. The selected spell check method may be a local spell check operation or a server-based spell check operation. For example, once a spell check operation has been performed, spell check function module 104 may retrieve spell check results from the selected spell check method and present to the user, via GUI 140, various spell check options. Spell check options may include, for example, viewing the potentially misspelled words, viewing proposed corrections for the potentially misspelled words, options to ignore a potentially misspelled word, options to place a potentially misspelled word in a personal dictionary (such as personal dictionary 130), and/or other spell check options. Spell check function module 104 may also present to the user, via GUI 140, an option for selecting a spell check method.

While a spell check operation may be performed at wireless hand-held device 102 using the dictionary stored at local spell check library 180, enhanced spell check operations may be performed at server 110. Server 110 may include a server-based spell check engine 120 and one or more databases, such as database 114. Database 114 may store any type of data or information, such as, for example, an extensive dictionary used by spell check engine 120. Server 110 may also include a personal dictionary 130. Personal dictionary 130 may allow the user to store words that were not found in database 114. Personal dictionary 130 may alternatively be stored at wireless handheld device 102.

One or more users may access server 110 and spell check engine 120 via a wireless hand-held device 102. Wireless hand-held device 102 is connected over a network 108 via one or more communication links 170, at least one or which may be a wireless communication link. Examples of wireless hand-held device 102 may include any one or more of, for instance, a Blackberry, a Personal Digital Assistant (PDA), web-enabled mobile phone, Palm Pilot, or other wireless hand-held device. Although the invention is described utilizing a wireless hand-held device, it shall be understood by those skilled in the art that the invention may be utilized by any computer device which wishes to utilize spell check resources of a server.

According to some embodiments of the invention, server based spell check engine 120 may include a processing module 106. Processing module 106 may provide one or more features that provide a more thorough spell check operation for wireless hand-held device 102 by utilizing spell checking resources of server 110. For example, server 110 may have increased processing power, increased memory, a larger lexicon, a larger or more extensive dictionary, and/or other spell check resources.

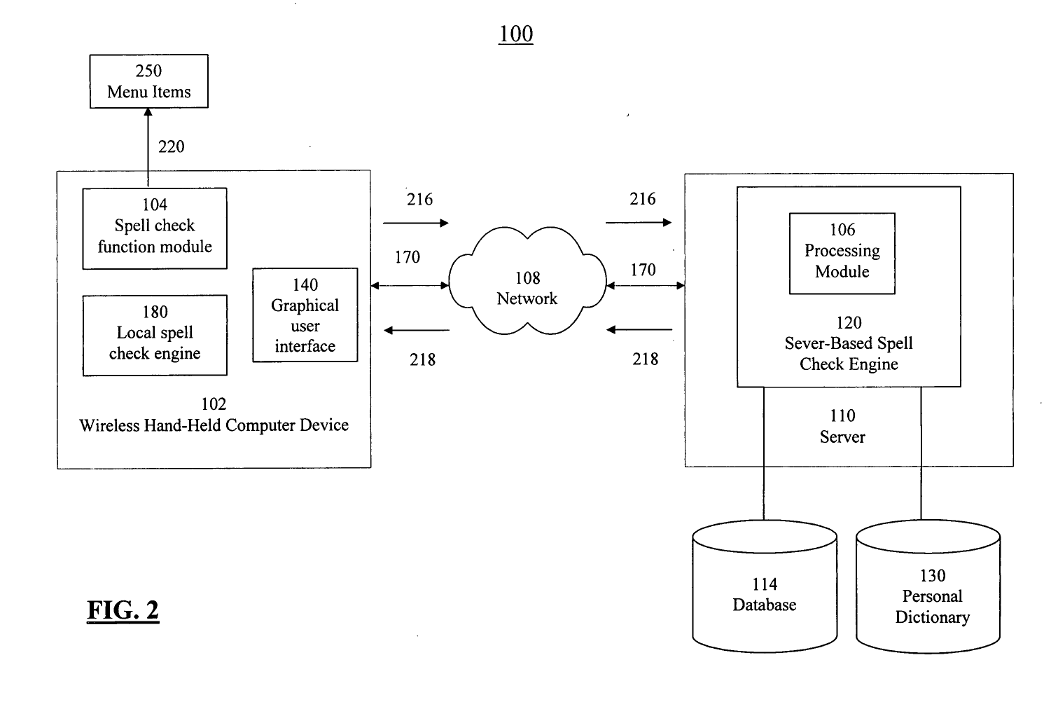

FIG. 2 illustrates a data flow that may be used by system 100 to perform a server-based spell check, according to various embodiments of the invention. A user may select server-based spell check engine 120 as a default spell check method to be used for example, prior to each time an email is sent. Alternatively, the user may select the spell check method at the time of each individual spell check process. A user may initiate a spell check request, as illustrated at an action 216. The user request may include the transmission of text that the user wishes to have spell checked. According to various embodiments of the invention, the user may send text as an entire document, a portion of a document, a list of words thought to be potentially misspelled, a list of words not checked by local spell check engine 180, or any other text to be spell checked. Spell check function module 104 may cause user request 216 to be transmitted to server 110. The spell check request may be transmitted to server 110 via email or other known electronic distribution mechanism.

Upon receipt of user request 216, processing module 106 of spell check engine 120 may perform the spell checking process on the text associated with user request 216. As such, the spell checking process may be performed remotely at server 110. Server 110 spell checks the text according to processes well known in the art, and may present indicia identifying each word that is potentially misspelled as a part of the spell check results. Indicia may include, for example, underlining potentially misspelled words, highlight the potentially misspelled words, changing the color of potentially misspelled words in the text, providing a list of potentially misspelled words, and/or other indicia. This indicia may be provided for the potentially misspelled words in the original text as a list or other mechanism for identifying the potentially misspelled words.

Results may be transmitted back to wireless hand-held device 102, as illustrated at an operation 218. Spell check function module 104 on wireless hand-held device 102 may process the search results upon receipt. In some embodiments of the invention, spell check function module 104 may generate menu items 250 corresponding to each potentially misspelled word based on the provided indicia.

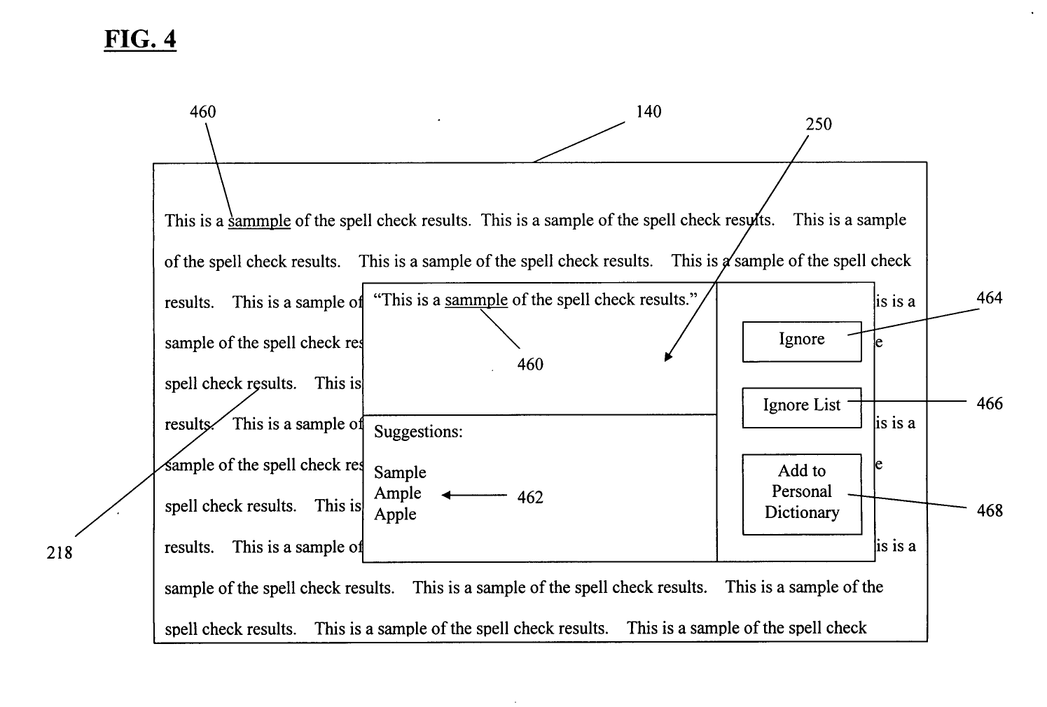

Menu items 250 may include items that the user sees when viewing results 218. FIG. 4 illustrates various menu items that may be presented to the user, according to various embodiments of the invention. These menu items may include, for example, a list of available correction options 462 for a potentially misspelled word 460, the option 464 to ignore potentially misspelled word 460, the option to place allegedly misspelled word 460 to a saved “ignore list” 466 of personal dictionary 130, the option to add 468 allegedly misspelled word 460 or a corrected spelling to personal dictionary 130, or any other menu item that may be associated with the spell check process. While misspelled word 460 is indicated in FIG. 4 by underlining, other indicia may be provided, as discussed above.

As illustrated in FIG. 4, spell check function module 104 on wireless hand-held device 102 provides results 218 to a user via GUI 140. FIG. 4 illustrates a potentially misspelled word 460 (e.g., “sammple”). A list of available correction options 462 which may be provided includes three suggestions for correcting potentially misspelled word 460: “sample, ample, and apple”. As illustrated, spell check function module 104 may cause potentially misspelled word 460 to be underlined to flag it for the user, or may cause potentially misspelled word 460 to be displayed in any other appropriate display form. For instance, potentially misspelled word 460 may also be displayed in bold type, highlighted, or reproduced in a color different from the color of the correctly-spelled text.

Spell check function module 104 enables a user to correct misspellings by making selections from, for example, a list of available correction options 462. If none of the different correction options represent the word desired by the user, spell check function module 104 may enable the user to choose to ignore potentially misspelled word 460, as illustrated at 464. Alternatively, the user may manually type in a correct spelling. In addition, spell check function module 104 may enable a user to place potentially misspelled word 460 in an “ignore list” 466 of personal dictionary 130, add potentially misspelled word 460 or a corrected spelling to personal dictionary 130 as illustrated at 468, or any other feature that may be associated with the spell check process. Personal dictionary 130 may be saved on the wireless hand-held device 102, saved on server 110, or both.

Referring again to FIG. 2, wireless hand-held device 102 may be a Blackberry, according to one embodiment of the invention. Server 110 may accordingly be a Blackberry Enterprise Server, which is well known the art as associated with a Blackberry hand-held device. A user may generate user request 216 by initiating the spell check process. User request 216 may be transmitted to the Blackberry Enterprise Server as an email with the text to be spell checked attached to or otherwise included in the email. In some embodiments of the invention, the email may include a subject line that signals to the Blackberry Enterprise that the text attached to or included in the email should be spell checked using the server-based spell check engine 120. Processing module 106 of spell check engine 120 may perform the spell checking process on the text, generate indicia as described above, and transmit results 218 back to the Blackberry hand-held device.

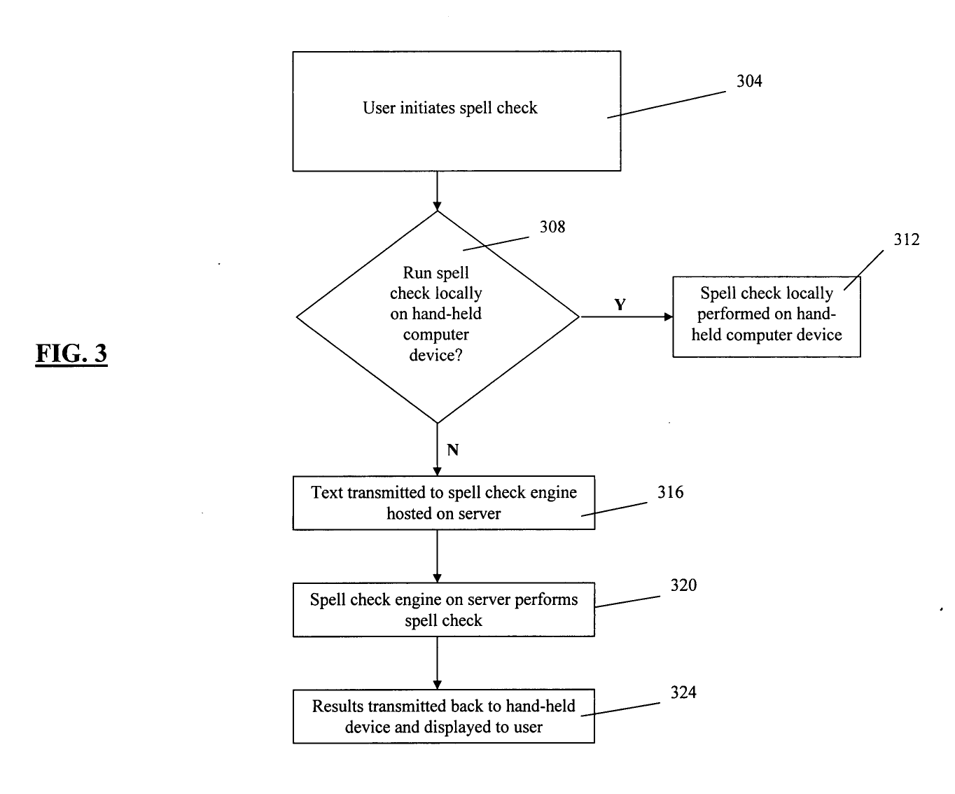

FIG. 3 illustrates a flowchart for performing a spell check operation, according to various embodiments of the invention. Prior to operation 304, a user operating a wireless hand-held device may input text using one or more known word-processing applications, electronic mail applications, or other applications that enable users to input text. One or more of these applications may, for instance, incorporate, interface with, or otherwise operate with a spell check engine hosted on the wireless hand-held device. In some embodiments of the invention, a user interface presenting spell check options and results may be separate from the processing functions of a spell check engine. For example, processing functions may be performed on a hand-held device or on a remote server. The spell check options and results may be presented on a user interface of the wireless hand-held device regardless of where the processing functions occurred.

In an operation 304, a user may initiate the spell check process for the inputted text. The user may view available features and functions associated with the spell check process using the graphical user interface (GUI) of the wireless hand-held device.

In an operation 308, a determination is made regarding whether the user wishes to perform a spell check locally, using a local spell check engine hosted by the wireless hand-held device, or via a more powerful spell check engine hosted by a remote server. The determination of which spell check engine to use may be made automatically through a default selection by the user or by general preference settings. Alternatively, the determination may be made by the user each time an individual spell check process is invoked.

If the determination is made to perform the spell check locally, then the spell check process is performed by a spell-check program operating on the wireless hand-held device as illustrated at an operation 312. The spell check program operating on wireless hand-held device 312 may use local spell check library 180 to access a dictionary. Processing by the local spell check engine may be more limited than processing by the server-based spell check engine, but may suffice if a user wishes to perform only a cursory spell check.

If it is determined that the user wishes to have the spell check performed by a spell check engine on a remote server, the text to be spell checked may be transmitted to a spell check engine hosted on a remote server in an operation 316. A server-based spell checking engine may include a number of enhanced resources such as increased processing power and memory, a larger lexicon, a larger dictionary, or other enhanced spell-checking resources.

According to some embodiments of the invention, a user may choose to have a portion of the spell check performed at the handheld device and a portion of the spell check performed at the server. For example, the user may, after performing a local spell check operation be presented with an option to check any words not checked by the local spell check operation at the server. In some embodiments, the local spell check operation may be used to check only those words stored in a personal dictionary located at the wireless handheld device, or using a local spell check library. The local spell check library, as described above, may include only a portion of a larger dictionary comprising, for example, the most commonly used words. After performing a spell check using the local spell check library or a personal dictionary stored at the wireless handheld device, the user may be presented with results indicating which words were not checked by the local spell check operation, and an option to spell check these words at the server. The user may also be presented with the option to spell check the entire text at the server.

In operation 320, the spell check process is performed on the server. Once processing on the server is complete, results may be transmitted back to the wireless hand-held device in an operation 324. The results may be in a format that incorporates the original text, such as underlining, highlighting, changing the color, or otherwise indicating a misspelled word within the text. The results may use other formats that do not directly incorporate the original text, such as, for example, presenting a list of misspelled words along with an annotation indicating the location of the misspelled words in the original text. The results may also include potential corrections for each allegedly misspelled word.

Other embodiments, uses and advantages of the invention will be apparent to those skilled in the art from consideration of the specification and practice of the invention disclosed herein. The specification should be considered exemplary only, and the scope of the invention is accordingly intended to be limited only by the following claims.

1. A method of performing a spell check operation for one or more documents on a wireless handheld device comprising:
in response to an action by a user, initiating a spell check operation on one of said one or more documents;
transmitting the selected document to a remote server hosting a server-based spell check engine;
receiving, from the remote server, results of the spell check operation, wherein the results include indicia identifying one or more misspelled words; and
presenting the results to the user.

2. The method of claim 1 further comprising:
receiving input from the user to select one or more options to correct the one or more identified misspelled words.

3. The method of claim 2 wherein said one or more options includes at least one of selecting a suggested correction, ignoring the indicated misspelled word, and adding the misspelled word to a personal dictionary.

4. The method of claim 1 further comprising:
receiving an input from the user to select an identified misspelled word;
presenting to the user one or more menu items, wherein the menu items present one or more correction options; and
performing a selected correction.

5. The method of claim 1 wherein the action by the user is selecting a server-based spell check option from at least two spell check options.

6. The method of claim 5 wherein one of said at least two spell check options is a local spell check option operating on the wireless handheld device.

7. A method for performing a spell check operation at a remote server for one or more documents on a wireless handheld device comprising:
receiving, at the server, a request to perform a spell check operation on one of said one or more documents, the request including the text of the selected document;
analyzing the selected document for spelling errors;
generating indicia identifying one or more misspelled words; and
transmitting to the wireless handheld device results of the spell check operation, the results including the identifying indicia.

8. The method of claim 7 wherein generating indicia further comprises generating a list of misspelled words.

9. The method of claim 7 wherein generating indicia further comprises underlining one or more misspelled words in the selected document.

10. The method of claim 7 wherein generating indicia further comprises highlighting one or more misspelled words in the selected document.

11. The method of claim 7 wherein the text of the selected document is received as an email attachment.

12. The method of claim 7 wherein the text of the selected document is received as the body of an email message.

13. The method of claim 7 wherein the text of the selected document is a portion of the document that was not processed by a spell check operation at the wireless handheld device.

14. The method of claim 7 wherein analyzing the selected document for spelling errors further comprises:
comparing each word in the selected document to a plurality of words in a stored spell check library;
comparing each word in the selected document to a plurality of words in a personal dictionary, wherein the personal dictionary includes one or more words stored by the user; and
wherein the spell check library and the personal dictionary do not include a word from the selected document, identifying the word as misspelled.

15. A method of performing a spell check operation for one or more documents on a wireless handheld device comprising:
in response to an action by a user, initiating a spell check operation on one of said one or more documents using a spell check library stored on the wireless handheld device;
generating spell check results wherein the results include indicia identifying one or more words in the selected document that were not checked for spelling;
presenting the user with an option to perform a spell check operation for the selected document using a server-based spell check operation housed on a remote server;
receiving input from the user to initiate the server-based spell check operation; and
transmitting text from the selected document to the remote server.

16. The method of claim 15 wherein transmitting text from the selected document to the remote server comprises transmitting a list of words that were not checked for spelling at the wireless handheld device.

17. The method of claim 15 wherein transmitting text from the selected document to the remote server comprises transmitting the text of the entire selected document.

18. A server based spell check system enabling a user of a wireless handheld device to remotely perform a spell check operation for one or more documents on the wireless handheld device comprising:
means for receiving a request from the wireless handheld device to perform a spell check operation on one of said one or more documents, the request including the text of the selected document;
means for analyzing the selected document for spelling errors;
means for generating indicia identifying one or more misspelled words; and
means for transmitting to the wireless handheld device results of the spell check operation, the results including the identifying indicia.

19. A server based spell check system enabling a user of a wireless hand-held device to remotely perform a complete spell check operation, the system comprising:
a processing module for receiving text transmitted from the wireless hand-held device and checking the text for one or more spelling errors;
a database for storing a large dictionary, said database used to compare one or more words in the received text to words stored in the dictionary; and
a personal dictionary for storing one or more user selected words, wherein the user selected words include at least one of the set of words commonly used by the user and words that were previously indicated as misspelled.
